(19) United States
(12) Patent Application Publication
(10) Pub. No.: US 2009/0057497 A1
(43) Pub. Date: Mar. 5, 2009

(54) Innovative Duct Bank Spacer

(75) Inventor: Thomas Albert Bradbury, Peoria, AZ (US)

Correspondence Address: THOMAS ALBERT BRADBURY, 10317 W. GRIS3WOLD RD., PEORIA, AZ, 85345, US

(73) Assignee: Thomas Albert Bradbury, Peoria, AZ (US)

(21) Appl. No.: 11/695,044

(22) Filed: Aug. 27, 2007

(51) Int. Cl. F16L 3/22

(52) U.S. Cl. 248/68.1; 138/113

(57) ABSTRACT

An Innovative Duct Bank Spacer allows the manipulation of the duct bank spacer to accommodate multiple conduit sizes in a single ready-made duct bank spacer. The inventive device includes PVC Pipe that is fitted thru drilled High Density Polyethylene (HDPE) slats. PVC pipe spacers are placed in between the HDPE slats to accommodate the conduit size and spacing needed and/or required. The PVC Pipe is glued into PVC couplings at each end of the Innovative Duct Bank Spacer to secure the placement of the PVC pipes. Two or more Innovative Duct Bank Spacers may be easily joined together with a piece of PVC pipe at either end to create an even larger duct bank spacer.

### BACKGROUND OF THE INVENTION

1. Field of the Invention

The present invention relates generally to Duck Bank Spacer and more specifically it relates to an Innovative Duct Bank Spacer that allows the manipulation of the duct bank spacer to accommodate multiple conduit sizes in a single ready-made duct bank spacer.

2. Description of the Related Art

It can be appreciated that duct bank spacer has been in use for many years. Typically, duct bank spacer is comprised of duct bank spacers that need to be assembled or that only accommodate one conduit size.

The main problem with conventional duct bank spacer is they do not accommodate multiple conduit sizes in a single ready-made duct bank spacer. Another problem with conventional duct bank spacer is they are not pre-assembled.

While these devices may be suitable for the particular purpose to which they address, they are not as suitable for accommodating multiple conduit sizes in a single ready-made duct bank spacer. The main problem with conventional duct bank spacer is they do not accommodate multiple conduit sizes in a single ready-made duct bank spacer. Another problem with conventional duct bank spacer is they are not pre-assembled.

In these respects, the Innovative Duct Bank Spacer according to the present invention substantially departs from the conventional concepts and a design of the prior art, and in so doing, provides an apparatus primarily developed for the purpose of accommodating multiple conduit sizes in a single ready-made duct bank spacer.

### SUMMARY OF THE INVENTION

In view of the forgoing disadvantages inherent in the known types of duct bank spacer now present in the prior art, the present invention provides a new Innovative Duct Bank Spacer construction wherein the same can be utilized for accommodating multiple conduit sizes in a single ready-made duct bank spacer.

The general purpose of the present invention, which will be described subsequently in great detail, is to provide a new Innovative Duct Bank Spacer that has many of the advantages of the duct bank spacer mentioned heretofore and many novel features that result in a new Innovative Duct Bank Spacer which is not anticipated, rendered obvious, suggested, or even implied by any of the prior art duct bank spacer, either alone or in any combination thereof.

To attain this, the present invention generally comprises PVC Pipe that is fitted thru drilled High Density Polyethylene (HDPE) slats. PVC pipe spacers are placed in between the HDPE slats to accommodate the conduit size and spacing needed and/or required. The PVC Pipe is glued into PVC couplings at each end of the Innovative Duct Bank Spacer to secure the placement of the PVC pipes.

There having thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an Innovative Duct Bank Spacer that will overcome the shortcomings of the prior art devices.

An object of the present invention is to provide an Innovative Duct Bank Spacer for accommodating multiple conduit sizes in a single duct bank spacer.

An object of the present invention is to provide an Innovative Duct Bank Spacer in a ready-made duct bank spacer.

Another object is to provide an Innovative Duct Bank Spacer that is manipulative to various sizes, styles and types of conduit.

Another object is to provide an Innovative Duct Bank Spacer that is more easily used during the installation of conduit.

Another object is to provide an Innovative Duct Bank Spacer that is that may be utilized either with the HDPE slats vertical or horizontal.

Another object is to provide an Innovative Duct Bank Spacer that does not affect the overall balance of the conduit.

Another object is to provide an Innovative Duct Bank Spacer that assures the correct and accurate spacing of the conduits being placed thru the Innovative Duct Bank Spacer.

Another object is to provide an Innovative Duct Bank Spacer that assures the conduits being placed thru the Innovative Duct Bank Spacer are secure.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a perspective view of the present invention.

FIG. 2 is an exploded view of the present invention showing all of the components.

FIG. 3 is a diagram illustrating the components that allow for slurry flow between the conduits.

FIG. 4 is a perspective view of the HDPE slats with the different holes drilled thru them.

FIG. 5 is a perspective view if the PVC Pipe with the PVC coupling glued onto the beginning piece.

FIG. 6 is a perspective view of the present invention showing the accommodation of different conduit sizes.

FIG. 7 is a perspective view of the present invention showing the accommodation of different conduit sizes.

FIG. 8 is a perspective view of the present invention showing the accommodation of different conduit sizes with the HDPE slats being utilized horizontally.

FIG. 9 is a perspective view of the present invention showing the accommodation of same conduit sizes.

FIG. 10 is a perspective view of the present invention showing the accommodation of different conduit sizes with a larger spacing requirement.

FIG. 11 is a top explode view of the present invention accommodating various conduit sizes in a single duct bank spacer.

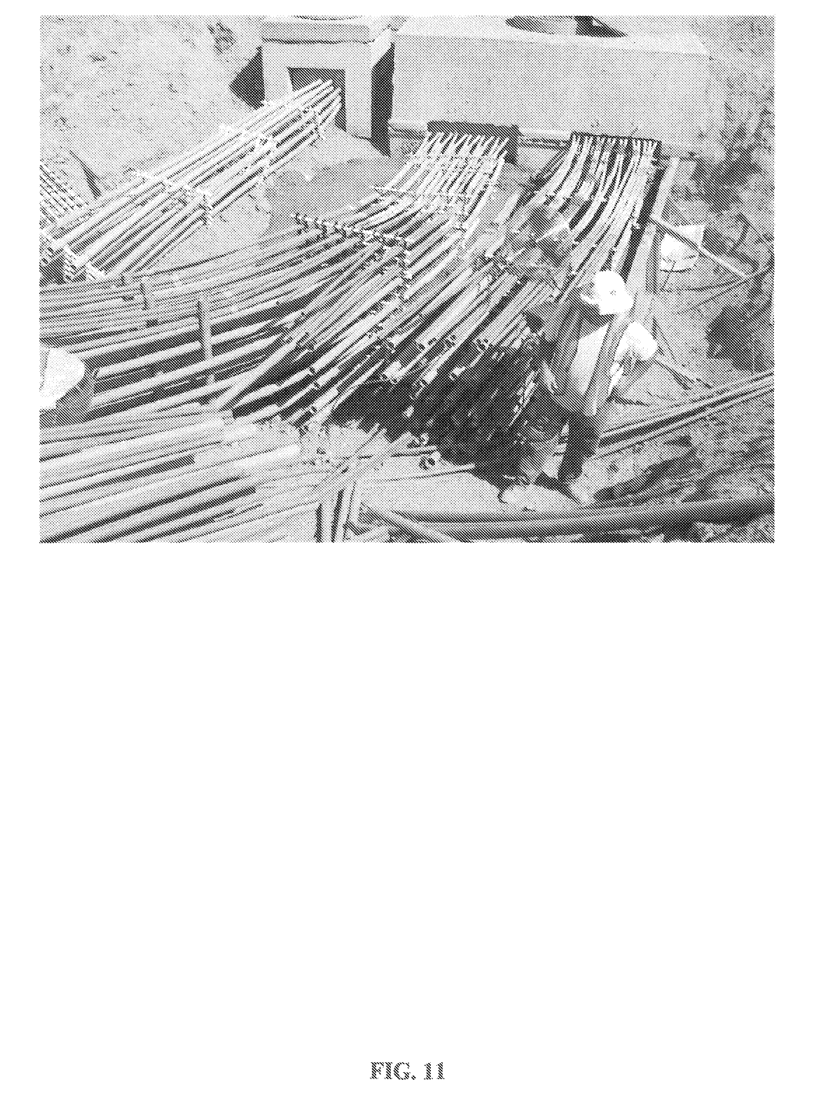

FIG. 12 is an exploded view of the present invention showing the actual make-up.

FIG. 13 is a top explode view of the present invention accommodating various conduit sizes in a single duct bank spacer.

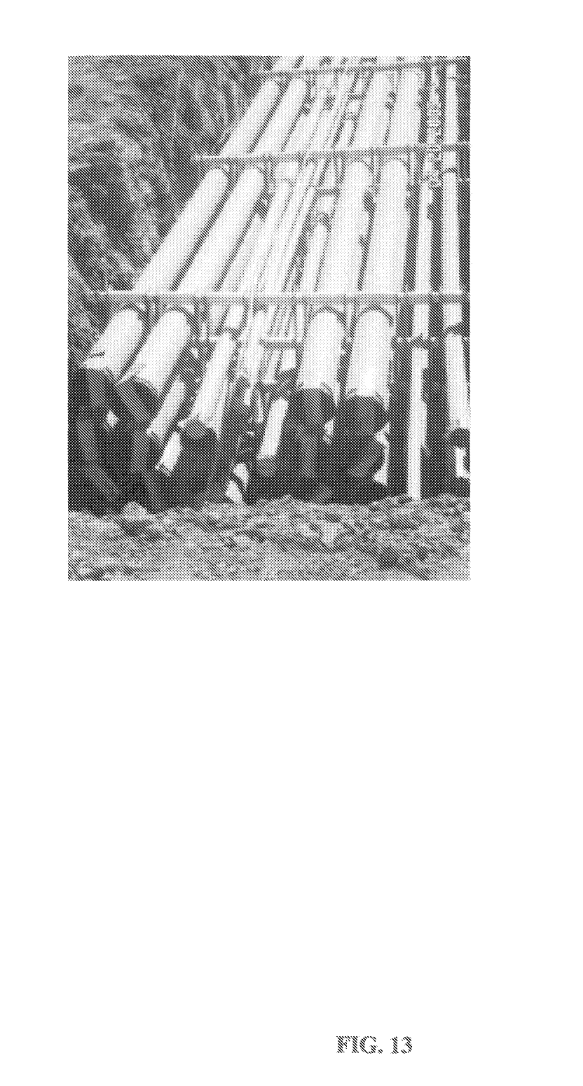

FIG. 14 is an aerial view of the present invention showing the actual practical workings accommodating various conduit sizes in a single duct bank spacer.

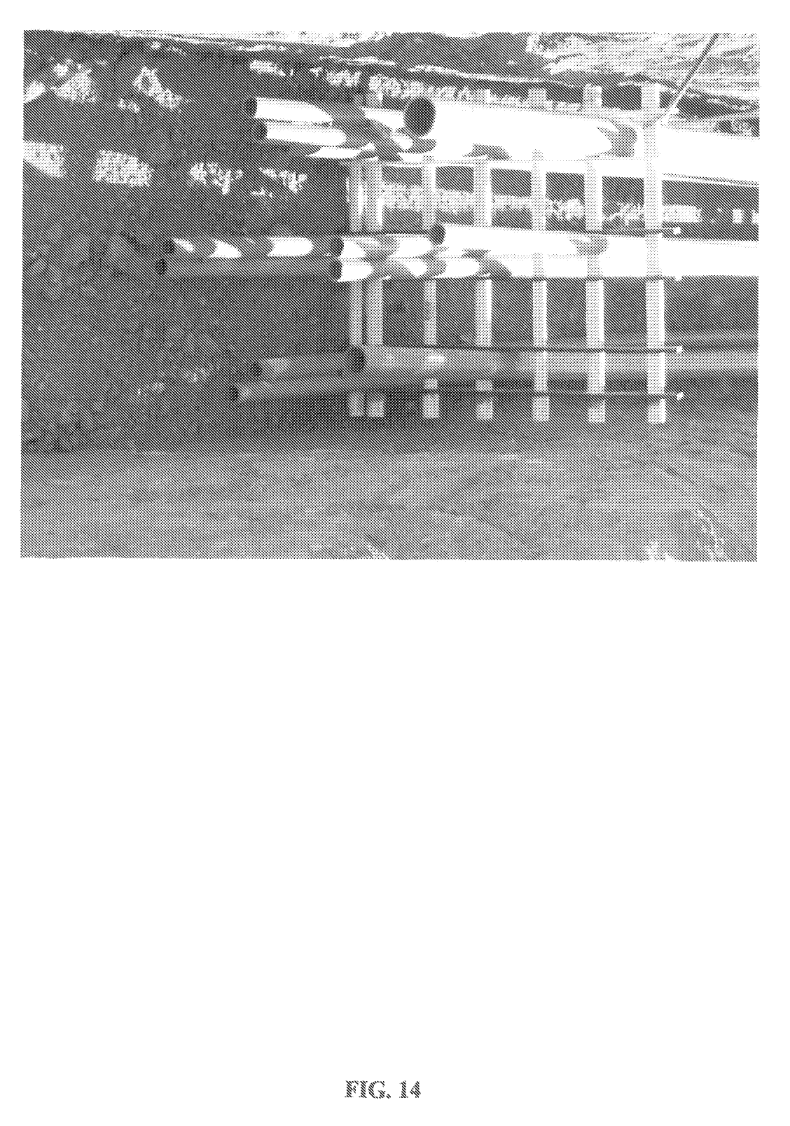

FIG. 15 is a side view of the present invention showing the actual practical workings accommodating various conduit sizes in a single duct bank spacer.

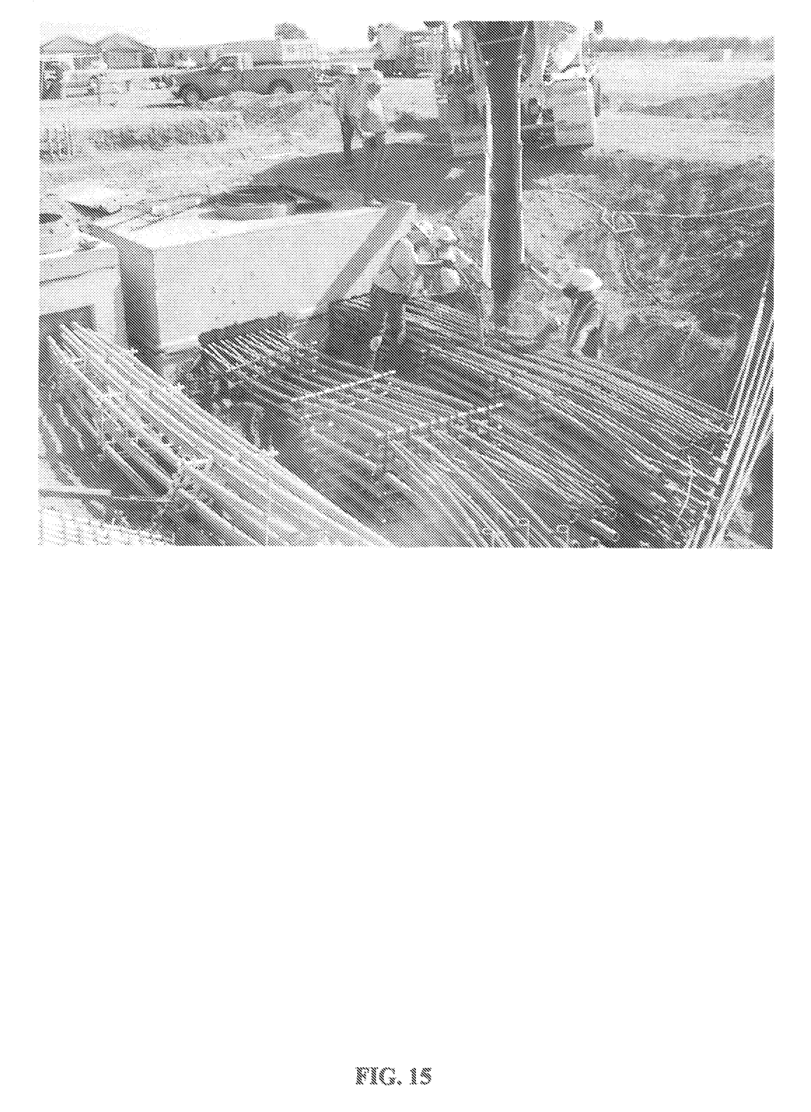

FIG. 16 is a top angle view of the present invention showing the use if two units being used together to create an even larger duct bank spacer.

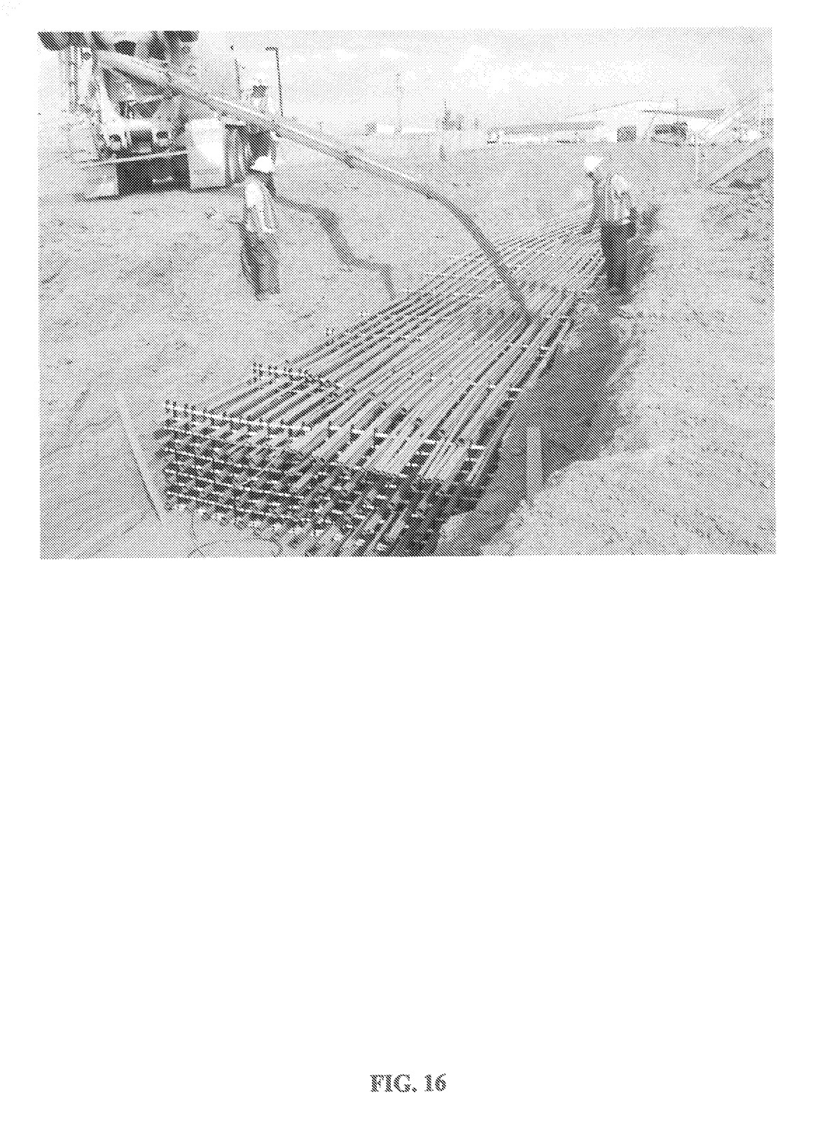

FIG. 17 is a side view of the present invention showing the practical use of the present invention.

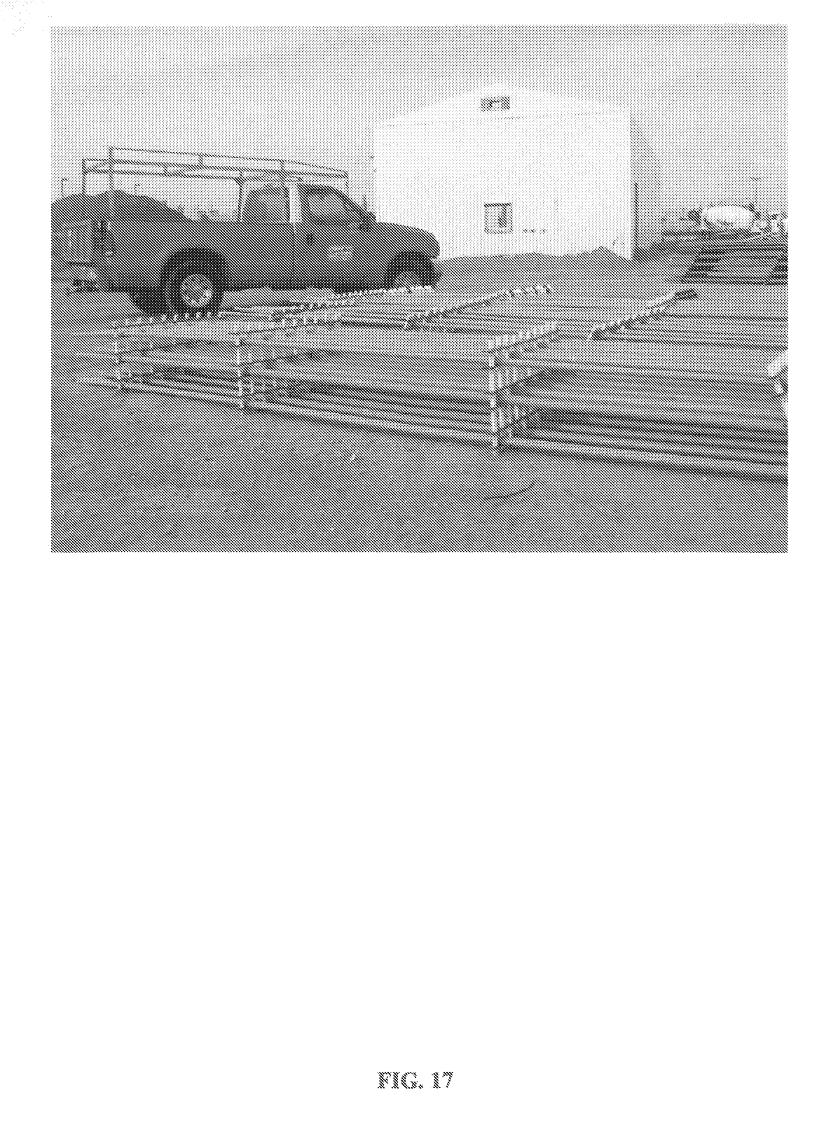

FIG. 18 is a top view of the HDPE slats with the different holes drilled thru them.

FIG. 19 is a top view if the PVC Pipe with the PVC coupling glued onto the beginning piece.

FIG. 20 is a top view showing the HDPE slats being placed over the PVC sticks, PVC spacers being placed between the slats followed by HDPE slats, etc. . . .

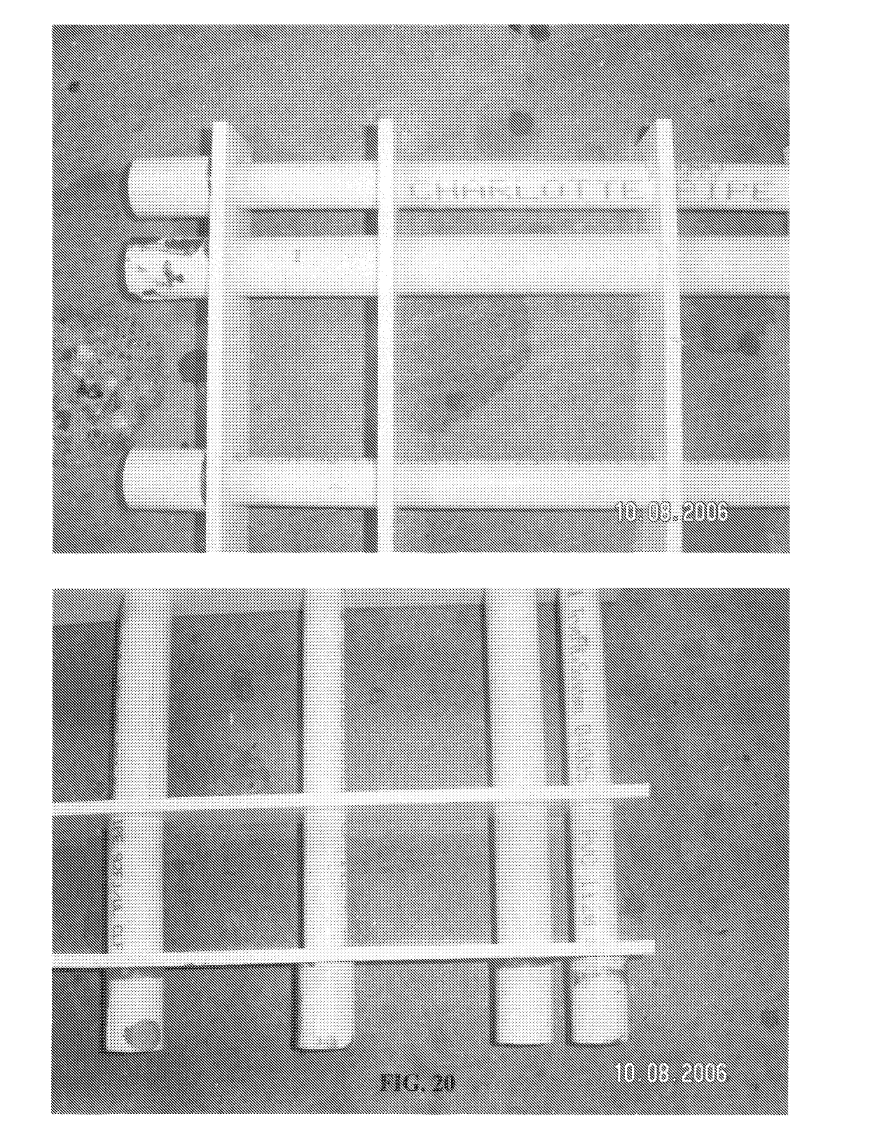

FIG. 21 is a view of a typical trench in which the present invention will be place.

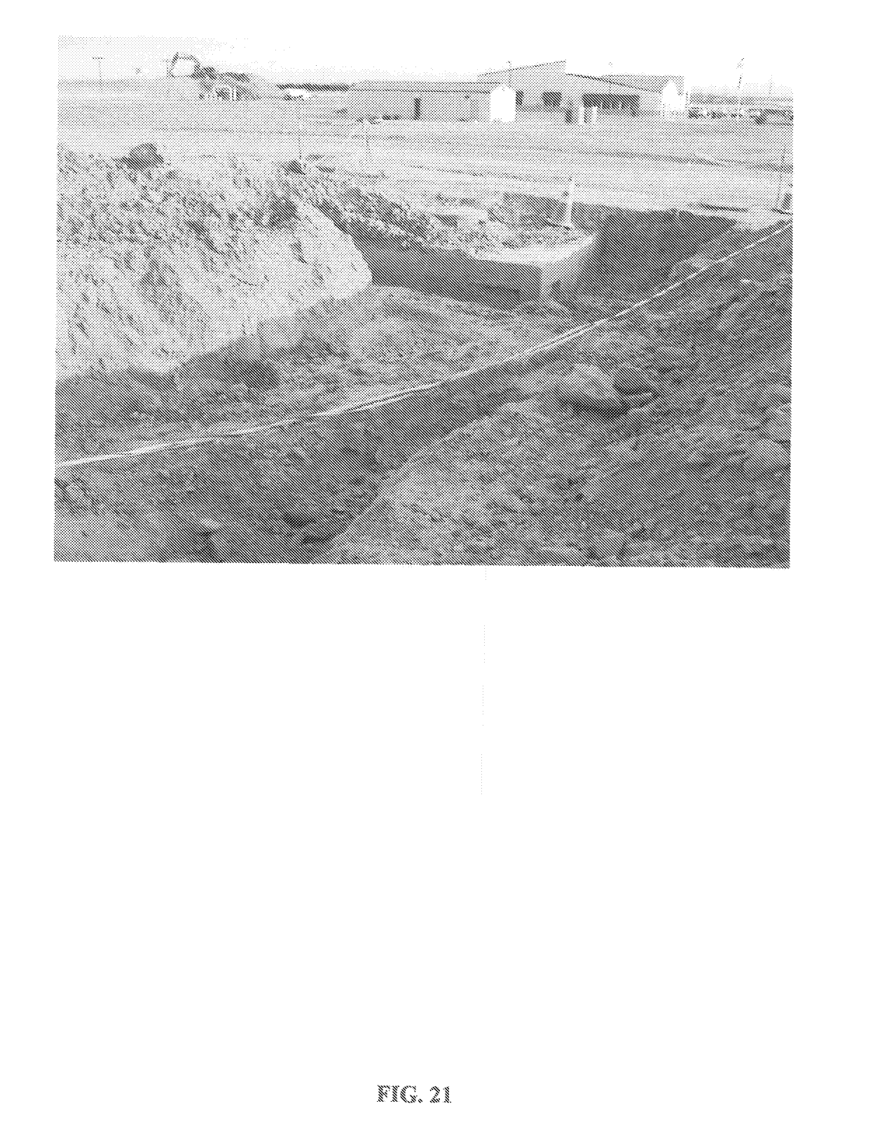

FIG. 22 is a top view of the present invention with the conduits being slid thru the openings.

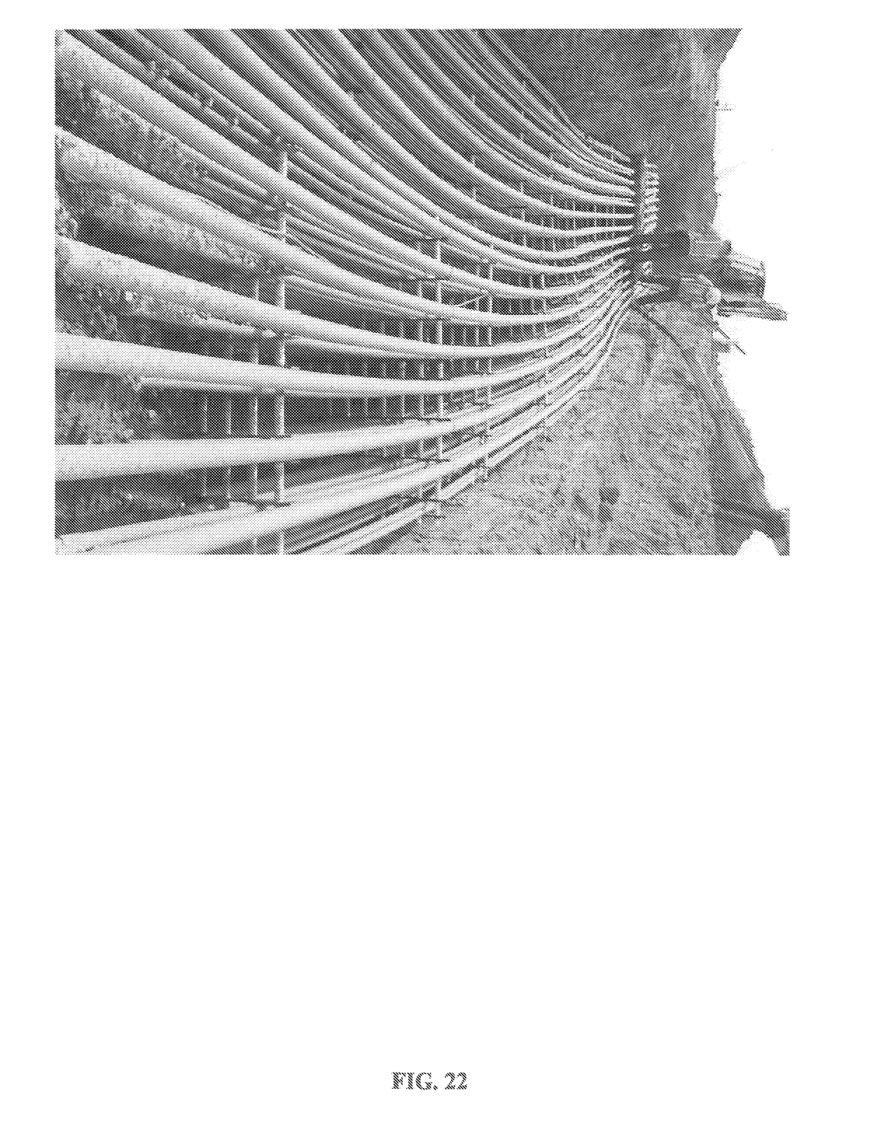

FIG. 23 is a top view showing the slurry being poured over the present invention after loaded with conduit.

### DETAILED DESCRIPTION OF THE INVENTION

Turning now descriptively to the drawings, in which similar reference characters denote similar elements throughout the several views, the attached figures illustrates an Innovative Duct Bank Spacer, which comprises a duct bank spacer that accommodates multiple conduit sizes in a single ready-made duct bank spacer. Two or more Innovative Duct Bank Spacers may be easily joined together with a piece of PVC pipe at either end to create an even larger duct bank spacer; thus creating an even more efficient and usable duct bank spacer. The present invention generally comprises PVC Pipe that is fitted thru drilled High Density Polyethylene (HDPE) slats. PVC pipe spacers are placed in between the HDPE slats to accommodate the conduit size and spacing needed and/or required. The PVC Pipe is glued into PVC couplings at each end of the Innovative Duct Bank Spacer to secure the placement of the PVC pipes.

The Innovative Duct Bank Spacer is constructed first, by determining the exact sizes of conduits being placed thru the Innovative Duct Bank Spacer and the exact spacing required by the utility company. The measurements are then calculated and the HDPE slats and PVC Pipe are cut accordingly. The long sticks of PVC Pipe are cut and a PVC coupling is glued into place at one end of each stick¹. 1 PVC spacer is slide over the PVC stick and will rest on top of the PVC coupling². Holes are then drilled into the slats of HDPE just large enough to accommodate the size of the PVC pipe being fitted ¹FIGS. 5 & 19²FIG. 1 thru the holes³. The PVC Pipe/coupling configuration is then placed thru the holes in the HDPE. A PVC Spacer is then slid over each of the PVC pipe sticks and will rest on top of the HDPE Slats. The sizes of the conduits being accommodated and the spacing required with dictate the sizes of the PVC spacers used⁴. Then another HDPE slat followed by a PVC spacer, etc . . . until the Innovative Duck Bank Spacer is complete⁵. Two or more Innovative Duct Bank Spacers may be easily joined together with a piece of PVC pipe at either end to create an even larger duct bank spacer⁶.³FIGS. 4 & 18⁴FIGS. 2 & 20⁵FIGS. 3, 6, 7, 8, 9, 10, 11, 12, 13, 14, 15, 16 & 18⁶FIG. 16

The PVC spacers are comprised of ¼″ larger PVC pipe (larger than the PVC Pipe sticks) cut into pieces to accommodate the spacing and conduit sizes⁷. ⁷FIG. 12

The HDPE slats are comprised of sheets of HPDE being cut into specified widths and lengths and having holes drilled into them at specific points to accommodate the different conduit sizes and spacing requirements⁸. ⁸FIGS. 4 & 18

Two or more Innovative Duct Bank Spacers may be easily joined together with a piece of PVC pipe at either end to create an even larger duct bank spacer⁹. ⁹FIG. 16

The user first gives the inventor the exact conduit sizes and spacing requirements. The present invention is then manufactured to the exact specifications required. The user then determines the exact location and placement of the present invention¹⁰. The user then lines up the present invention on the bank or in the trench of the project¹¹. The user then runs the conduits thru the openings in the Innovative Duct Bank Spacer and connects them accordingly ¹². If the assembled unit is on the bank of the trench, then the entire unit is lowered in to the trench. If it is already in the trench, no further steps are necessary before the slurry is poured. Once the assembled units are in place, slurry is poured over the entire unit, encasing it in its entirety¹³. ¹⁰FIG. 21¹¹FIG. 17¹²FIG. 22¹³FIG. 23

As to further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, for, function and manner of operation, assembly and use are deemed readily apparent and obvious to one skilled in the art, and all equivalent relationships to those illustrated in the drawings and described in the specifications are intended to be encompassed by the present invention.

Therefore, the forgoing is considered as illustrative only of the principles of the present invention. Further, since numerous modifications and changes will readily occur to those skilled in the art, it is not desired to limit the present invention to the exact construction and operation shown and described, and accordingly, all suitable modifications and equivalents may be resorted to, falling within the scope of the present invention.

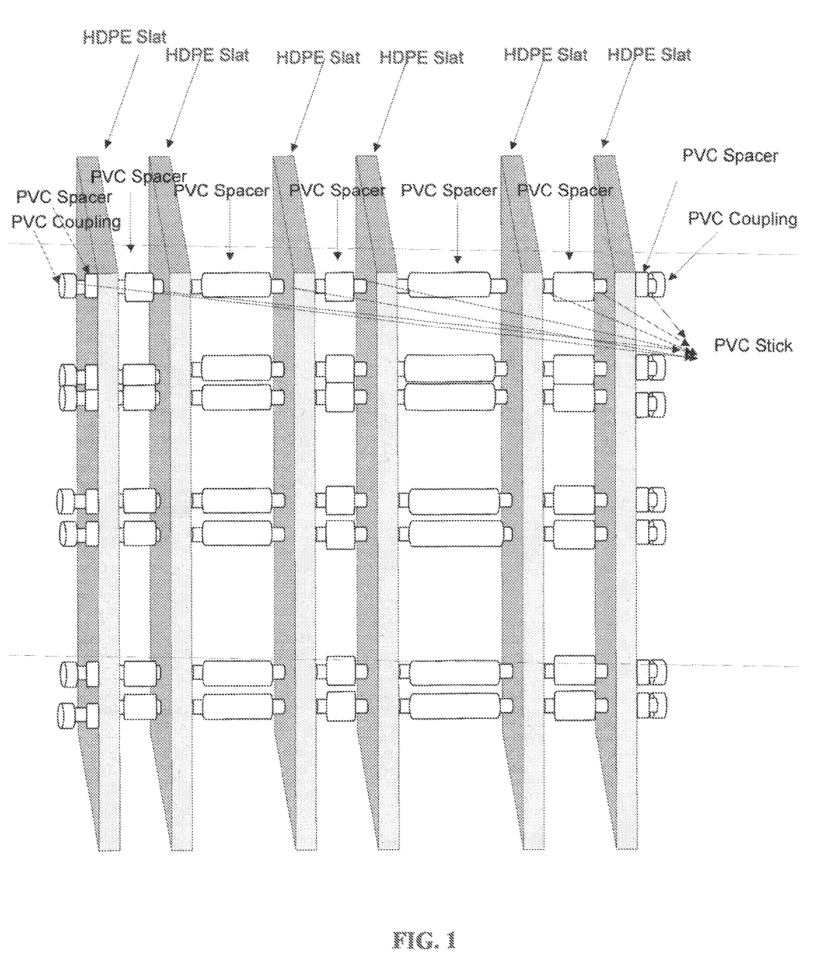

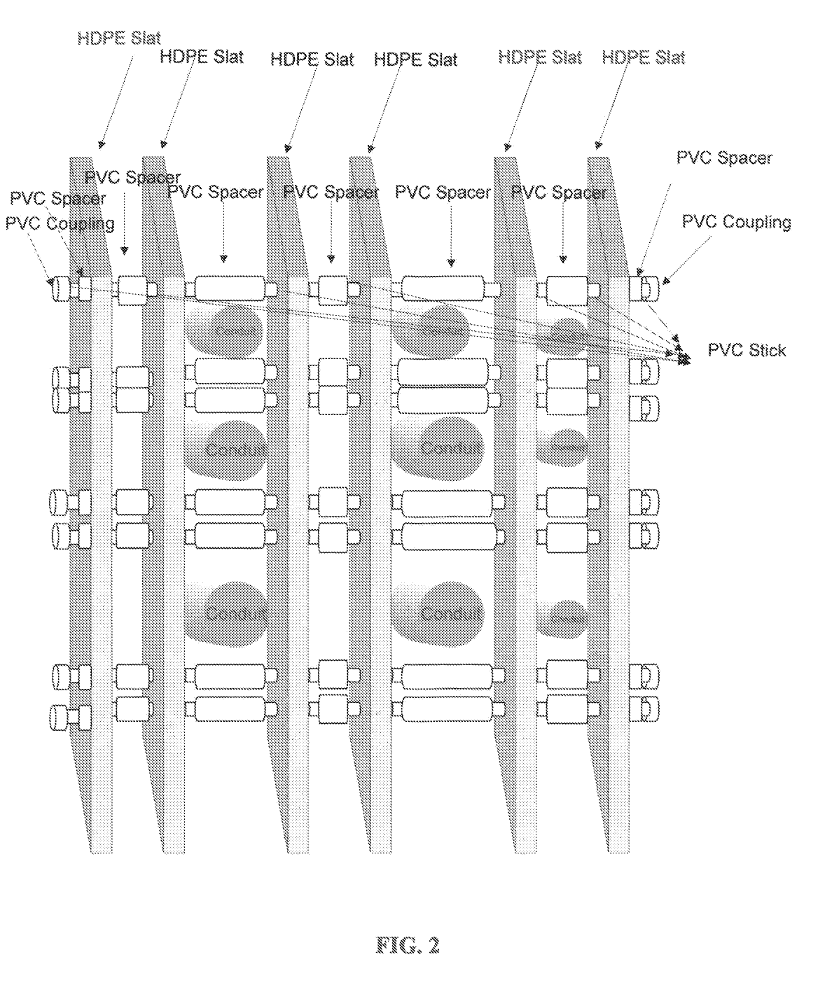

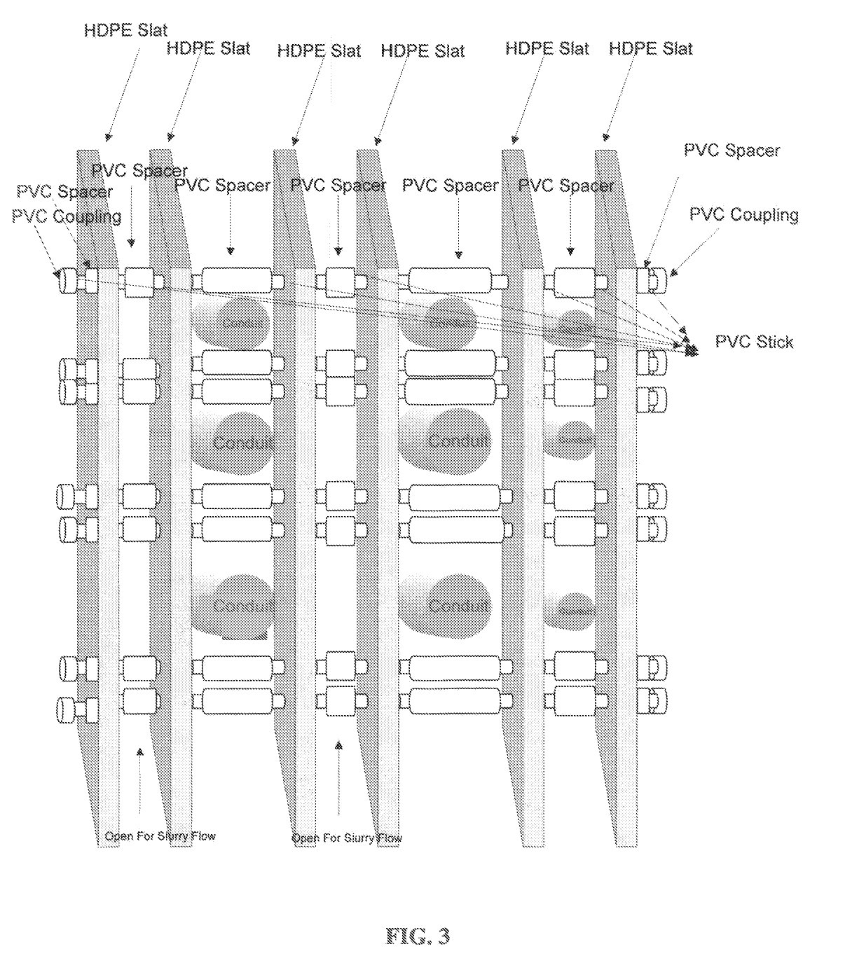

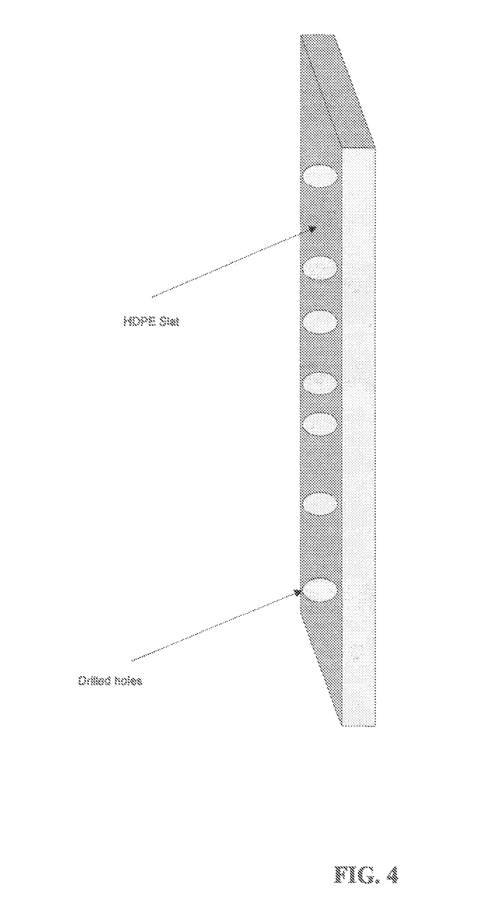

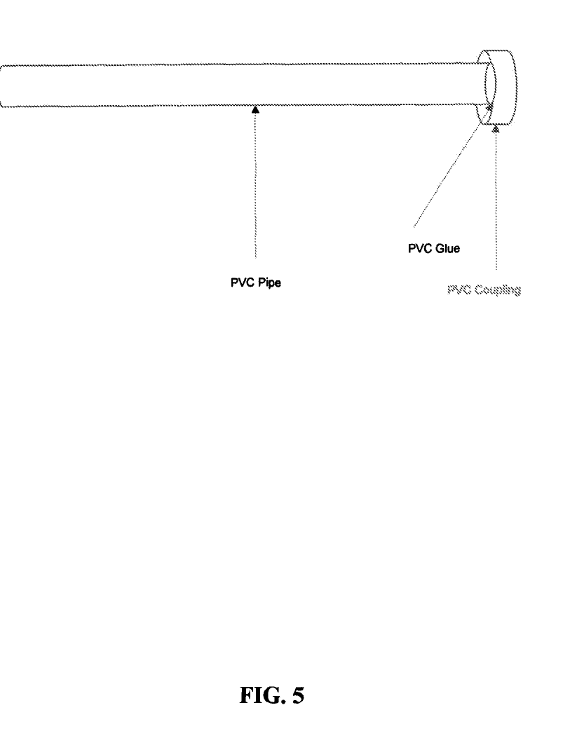

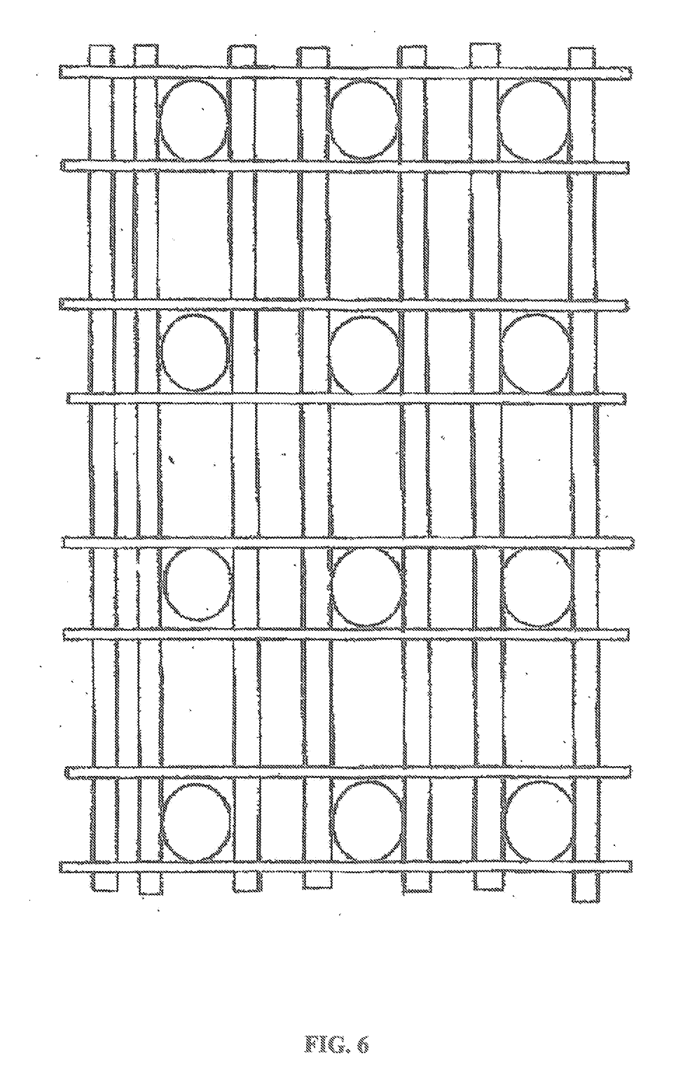

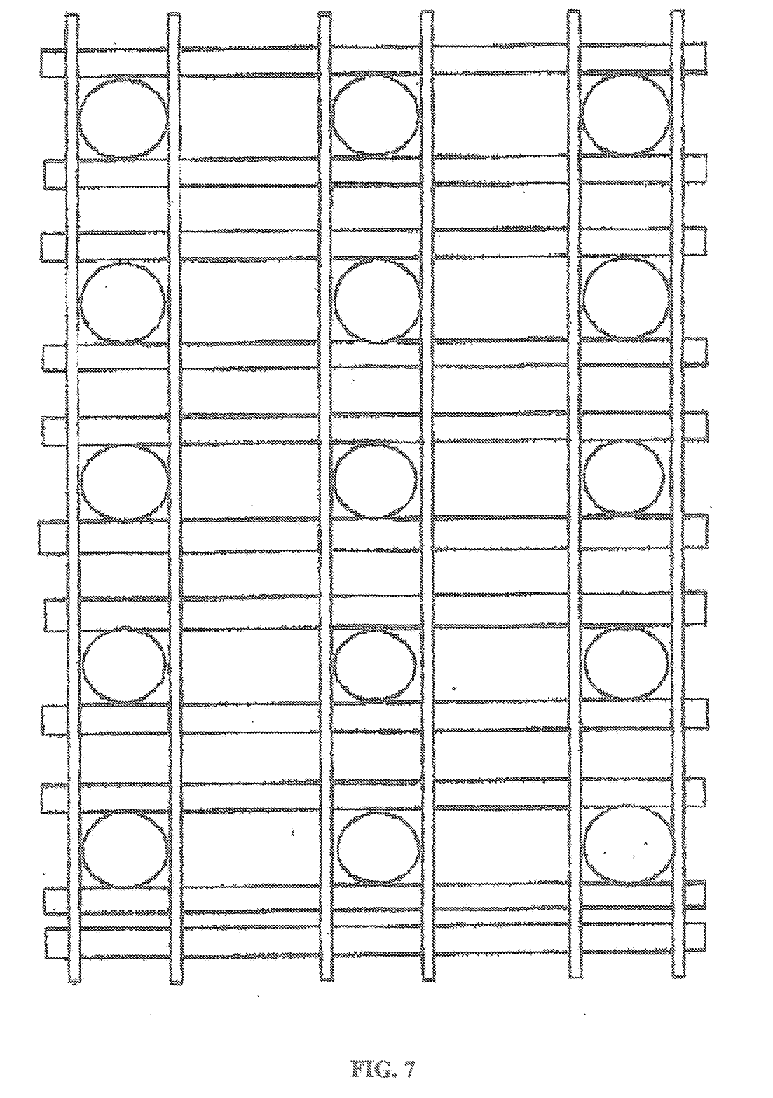

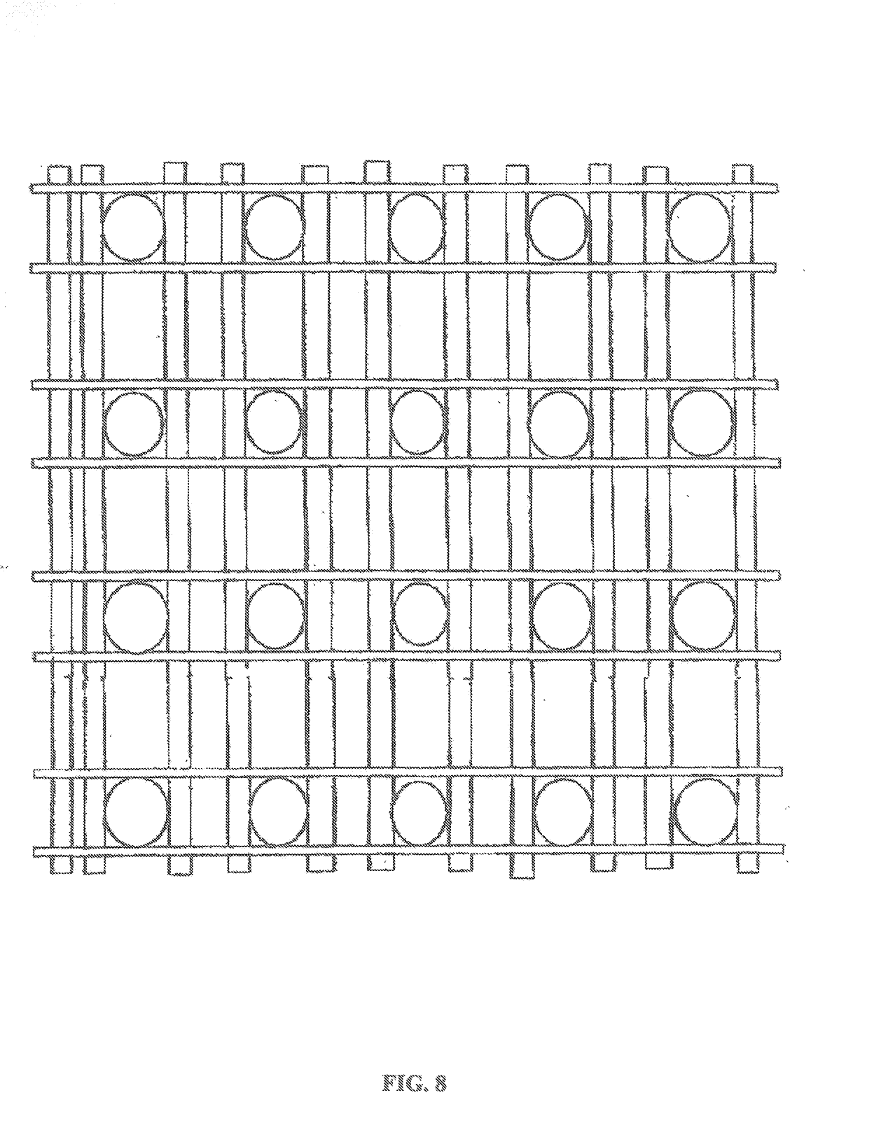

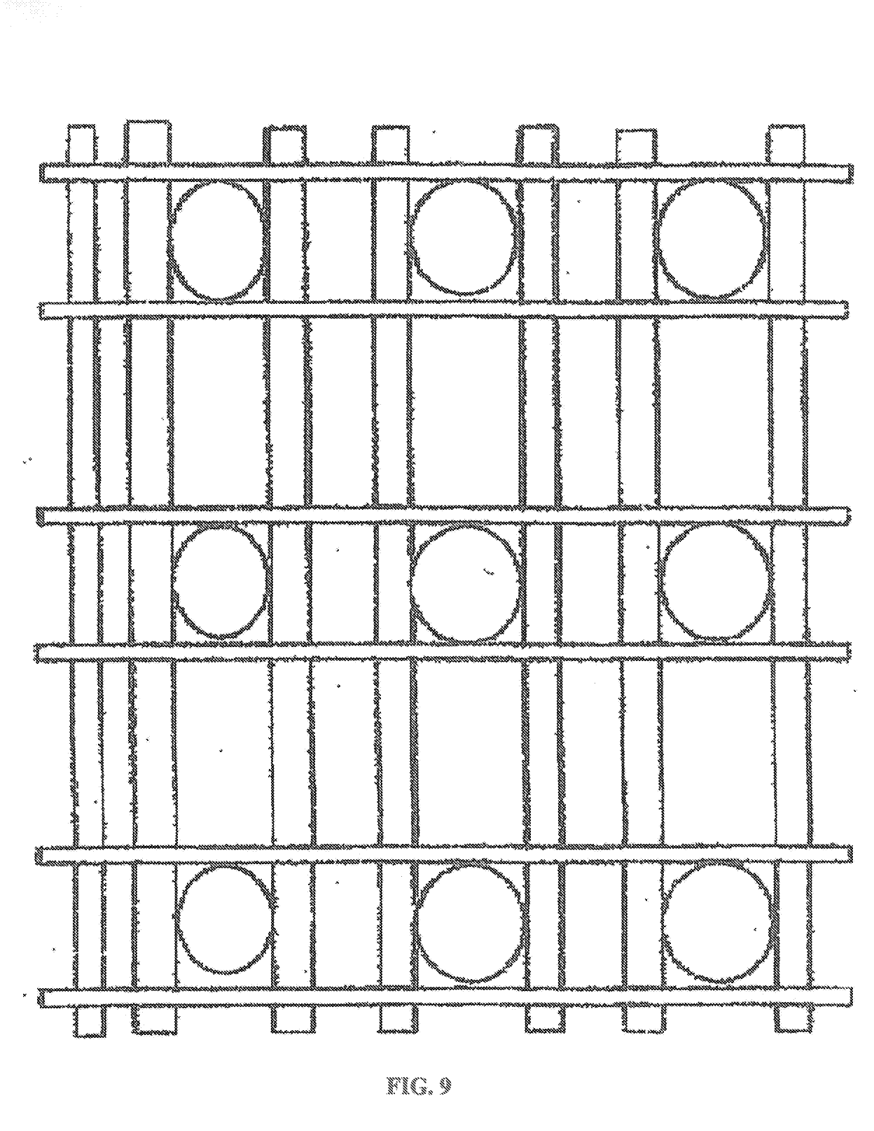

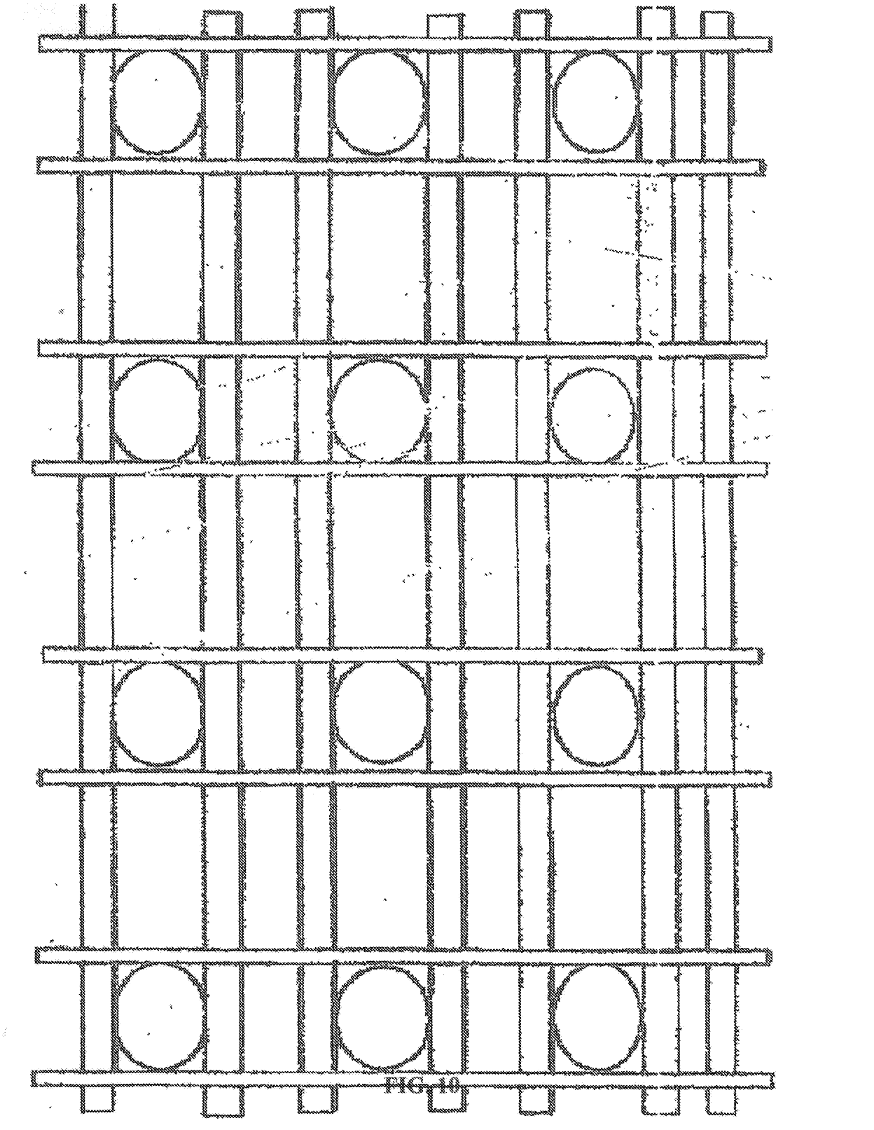

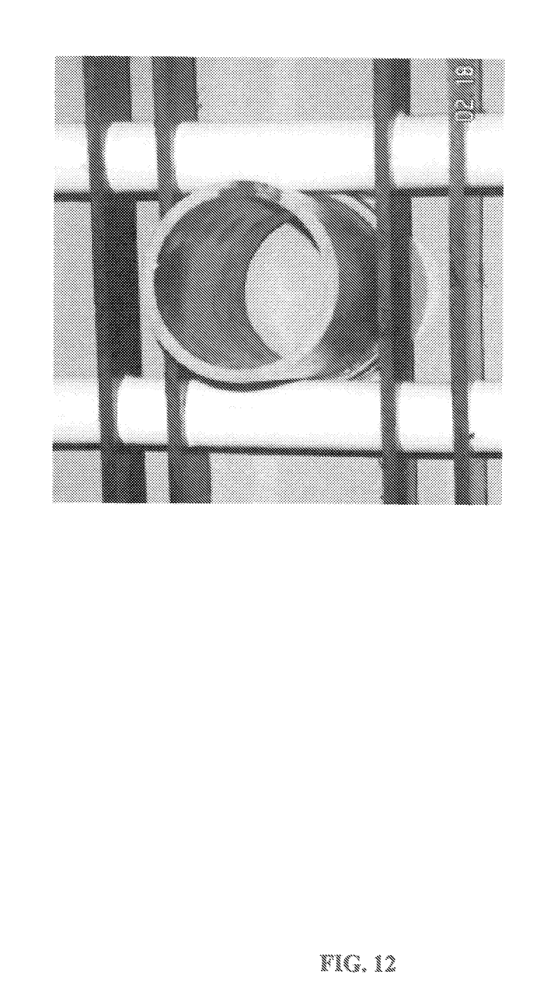

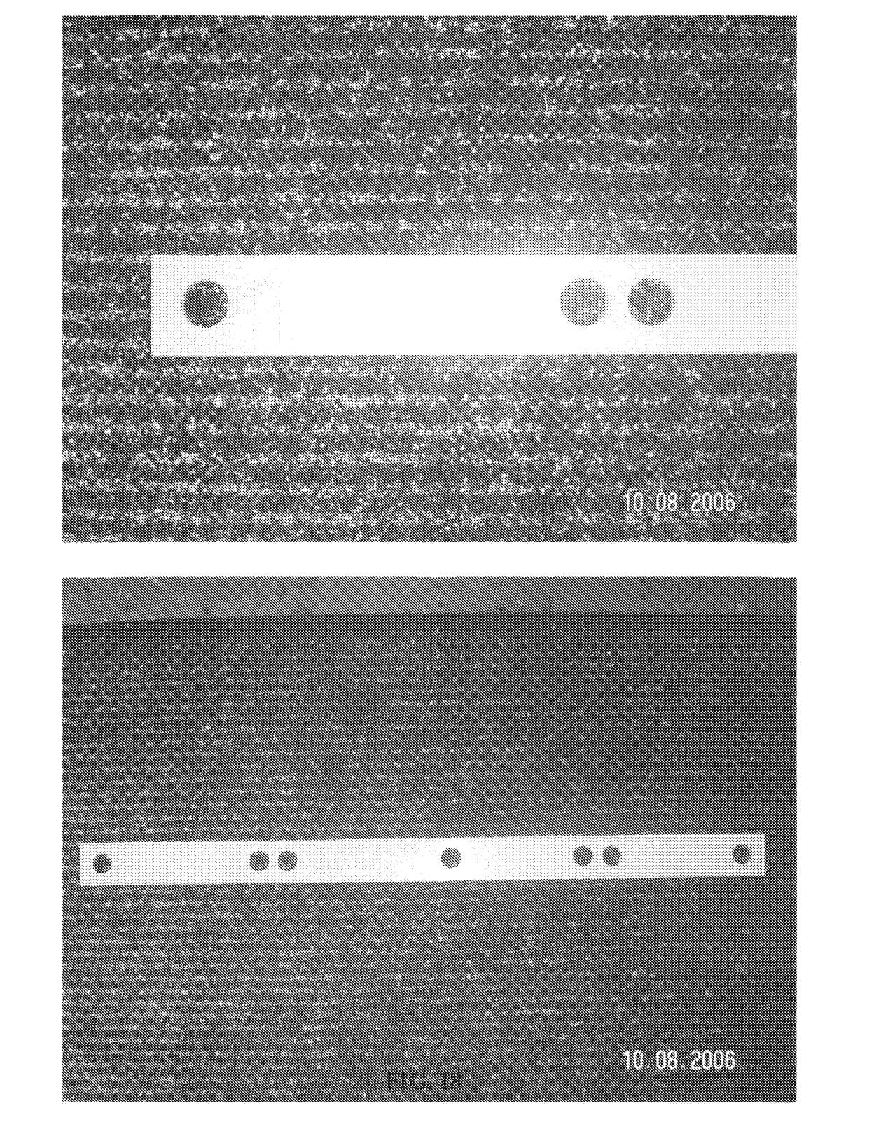

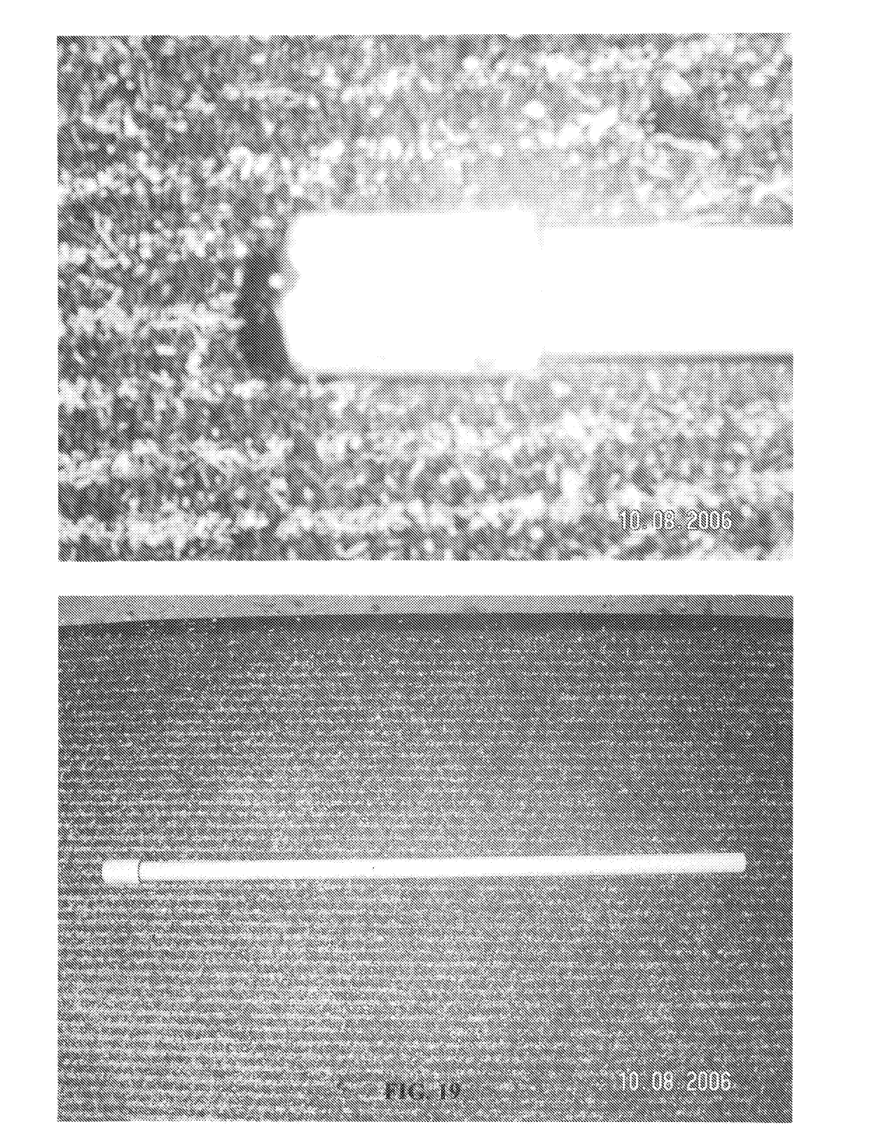

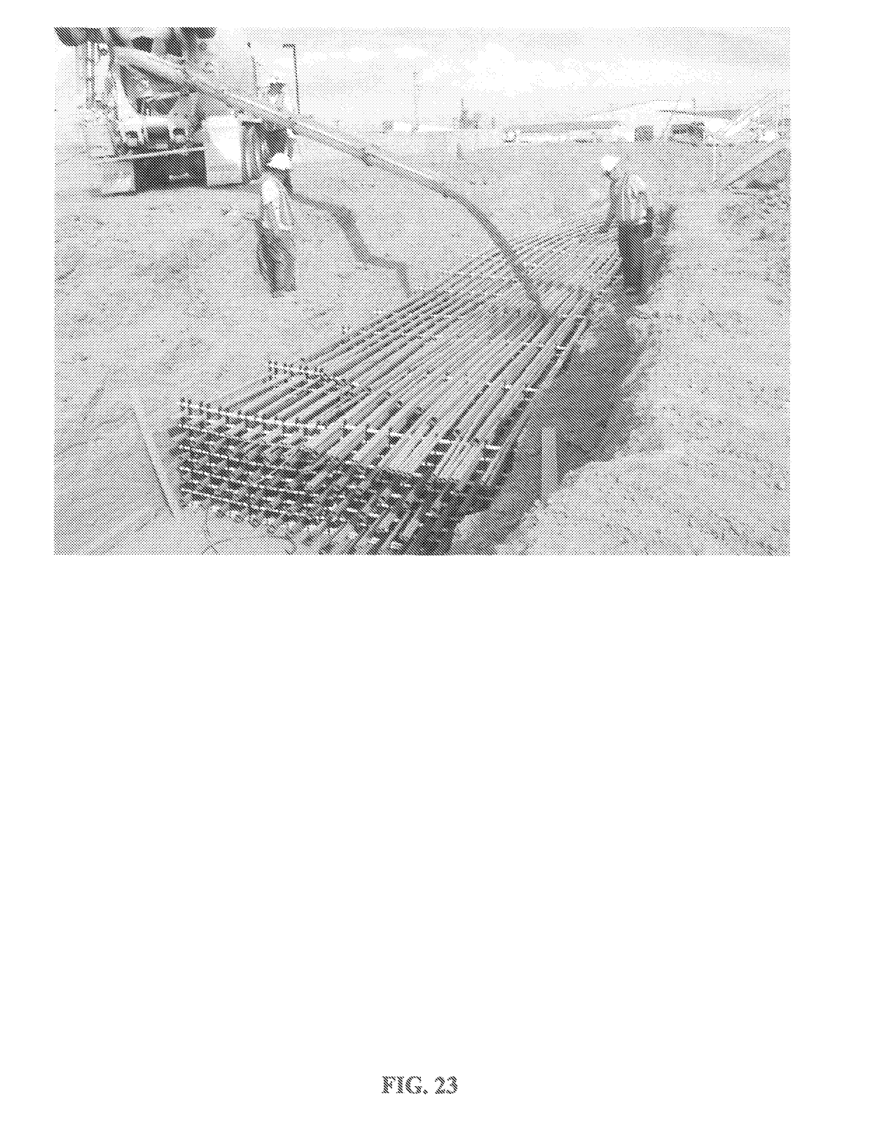

1. A design as shown in the figures a duct bank spacer comprising a plurality of pvc pipes with couplings glued on one end (FIGS. 5 and 19), a plurality of hdpe slats having holes drilled in them (FIGS. 4 and 18), a plurality of larger sized pvc pipes used as spacers (FIGS. 1 and 12), a plurality of pvc couplings glued on opposite ends of the pvc pipes securing placement of the hole-drilled hdpe slats and pvc spacers combination (FIG. 1), the plurality of coupling-glued pvc pipes being fitted thru the plurality of hole-drilled hdpe slats (FIG. 1), the plurality of larger sized pvc pipe spacers being fitted in between the hole-drilled hdpe slats (FIG. 2), the plurality of hdpe slats being again fitted over the pvc spacers (FIG. 3), the plurality of hdpe slats over pvc spacer process being repeated as necessary (FIG. 6-10), the plurality of pvc couplings being glued onto the opposite end of the plurality of pvc pipes securing the placement of the plurality of hdpe slat and pvc spacer combination (FIG. 1), such that the duct bank spacer may accommodate multiple sizes of conduit in a single ready-made duct bank spacer (FIG. 2, 3, 11, 13-17, 20, 22) that may be easily joined to another single ready-made duct bank spacer creating an even large ready-made duct bank spacer using a plurality of pvc pipes fitted into the plurality of glued coupling on either end of one duct bank spacer to the plurality of glued couplings of another duct bank spacer (FIG. 23) allowing slurry to flow freely around the conduits and duct bank spacer (FIG. 3, 15, 22, 23).
